(19) United States
(12) Patent Application Publication
(10) Pub. No.: US 2020/0048836 A1
(43) Pub. Date: Feb. 13, 2020

(54) METHOD FOR SPRAYING CHEMICAL SOLUTION

(71) Applicant: MAINTECH CO., LTD., Tokyo (JP)

(72) Inventors: Hiroshi SEKIYA, Tokyo (JP); Tomohiko NAGATSUKA, Fuji-shi, Shizuoka (JP); Kazuyuki YUSA, Fuji-shi, Shizuoka (JP); Ayano SUGA, Tokyo (JP)

(21) Appl. No.: 16/607,465

(22) PCT Filed: Mar. 28, 2019
(86) PCT No.: PCT/JP2019/013907

§ 371 Date: Oct. 23, 2019

(30) Foreign Application Priority Data
Mar. 30, 2018 (JP) PCT/JP2018/013980

(51) Int. Cl. D21F 7/00; D21F 5/02; B05B 13/04; B05B 13/02; B05D 1/28; B05D 1/02

(52) U.S. Cl. CPC D21F 7/00; D21F 5/02; B05B 13/0442; B05D 1/02; B05B 13/0278; B05D 1/28; B05B 13/0214

(57) ABSTRACT

[Problem]

To provide a method for spraying a chemical solution, including: spraying the chemical solution onto a surface of a dryer roller with a nozzle device reciprocated in the width direction of the dryer roller rotating at a high speed, whereby a sufficient amount of the chemical solution can be remained on the surface of the dryer roller.

[Solution]

The present invention is directed to a method for spraying a chemical solution, including: spraying the chemical solution onto a dryer roller by two nozzle devices disposed at a certain interval therebetween with the two nozzle devices each reciprocated along a rail extended in the width direction of the dryer roller, in a state that the dryer roller, for guiding wet paper, is being rotated, in a dry part of a paper-making machine, wherein a time T required for the two nozzle devices each to travel one-way is set as 0.2 to 1.5 minutes; a rotational speed Vd of the dryer roller is set as not less than 100 times/min; the number of contacts N that a point Q on the dryer roller surface makes contact with the wet paper during the time T is set as 30 to 250 times; the time T, the rotational speed Vd, and the number of contacts N satisfy the relationship of N=T*Vd; and the total amount of the sprayed chemical solution is set as 0.3 to 500 mg/m² as an effective component amount.

### TECHNICAL FIELD

The present invention relates to methods for spraying a chemical solution, and more particularly, to methods for spraying a chemical solution onto a dryer roller of a paper-making machine.

### BACKGROUND ART

A paper-making machine for manufacturing paper includes a dry part for heat-drying wet paper.

When the wet paper is fed to the dry part in the paper-making machine, the wet paper is pressed against a surface of a dryer roller by canvas, thereby being dried. At that time, the dryer roller rotates at approximately the same speed as a transportation speed (paper-making speed) of the wet paper.

There is a problem that adhesion of paper powder or pitch contained in the wet paper easily occurs in the dry part. Adhesion of paper powder or pitch to the dry part may cause the powder or the pitch to be transferred to the wet paper, leading to contamination of the wet paper.

In an attempt to solve this problem, methods for applying an anti-soiling agent to a dryer roller or canvas of a dry part by using a movable nozzle device have been developed (for example, see Patent Literature 1 to 5).

### CITATION LIST

### Patent Literature

PTL 1: Japanese Patent Application Laid-Open No. 2000-96478

PTL 2: Japanese Patent Application Laid-Open No. 2000-96479

PTL 3: Japanese Patent Application Laid-Open No. 2004-58031

PTL 4: Japanese Patent Application Laid-Open No. 2004-218186

PTL 5: Japanese Patent Application Laid-Open No. 2005-314814

### SUMMARY OF INVENTION

### Technical Problem

However, even with the methods for preventing contamination described in PTL 1 to 5, the adhesion of paper powder or pitch cannot be sufficiently prevented. That is, a certain effect is obtained by spraying a chemical solution onto a dryer roller in the methods for preventing contamination described in PTL 1 to 5. However, since the dryer roller makes contact with wet paper, the chemical solution given to a surface of the dryer roller is partially absorbed by the wet paper to be transported. Especially, as the rotational speed of the dryer roller corresponding to the transportation speed of the wet paper becomes high-speed, a number of times that a point on the surface of the dryer roller makes contact with the wet paper is increased, so that frequency that the chemical solution is absorbed by the wet paper is increased.

Then, the chemical solution amount at the point on the dryer roller surface runs short, which leads to the result that the effect by the chemical solution cannot be fully exhibited.

The present invention has been made in view of these circumstances, and it is an object of the present invention to provide methods for spraying a chemical solution, wherein the chemical solution can be sprayed onto a surface of a dryer roller with a nozzle device reciprocated in the width direction of the dryer roller rotating at a high speed, and a sufficient amount of the chemical solution can be remained thereon.

### Solution to Problems

The inventors of the present invention diligently studied in order to solve the problems mentioned above. As a result, the inventors found that the above-mentioned problems can be solved by identifying a total amount of a chemical solution to be sprayed, a time T required for two nozzle devices each to travel one-way, a rotational speed Vd of a dryer roller, and a number of contacts N that a point on the dryer roller surface makes contact with wet paper during the time T, and adjusting these to satisfy a fixed relationship in the identified ranges, and thus have completed the present invention.

A first aspect of the present invention is directed to a method for spraying a chemical solution, including: spraying the chemical solution onto a dryer roller by two nozzle devices disposed at a certain interval therebetween with the two nozzle devices each reciprocated along a rail extended in the width direction of the dryer roller in a state that the dryer roller, for guiding wet paper, is being rotated, in a dry part of a paper-making machine, wherein a time T required for the two nozzle devices each to travel one-way is set as 0.2 to 1.5 minutes; a rotational speed Vd of the dryer roller is set as not less than 100 times/min; a number of contacts N that a point on the dryer roller surface makes contact with the wet paper during the time T is set as 30 to 250 times; the time T, the rotational speed Vd, and the number of contacts N satisfy the relationship of N=T*Vd; and a total amount of the sprayed chemical solution is set as 0.3 to 500 mg/m² as an effective component amount.

A second aspect of the present invention is directed to a method for spraying a chemical solution according to the first aspect, wherein a first nozzle device of the two nozzle devices is arranged to reciprocate between a position corresponding to an end of the wet paper and a position corresponding to the center of the wet paper along the rail, and a second nozzle device thereof is arranged to reciprocate between a position corresponding to the other end of the wet paper and a position corresponding to the center of the wet paper along the rail.

A third aspect of the present invention is directed to a method for spraying a chemical solution according to the first or the second aspect, wherein an average moving speed Vn of the two nozzle devices is each set as 4 to 10 m/min; a paper width W of the wet paper is each set as 4 to 12 m; and the average moving speed Vn, the paper width W, and the time T satisfy the relationship of T=W/2Vn.

A fourth aspect of the present invention is directed to a method for spraying a chemical solution according to any one of the first to the third aspects, wherein a transportation speed Vp of the wet paper is set as not less than 600 m/min; a diameter D of the dryer roller is set as 1.50 to 1.85 m; and the rotational speed Vd, the transportation speed Vp, and the diameter D satisfy the relationship of Vd=Vp/πD.

A fifth aspect of the present invention is directed to a method for spraying a chemical solution according to any one of the first to the fourth aspects, wherein the two nozzle devices, having the same construction, are each arranged to spray the chemical solution onto the dryer roller radially and a width of a sprayed portion on the dryer roller of the chemical solution sprayed instantaneously by the nozzle device is set as 1.5 to 9 cm.

A sixth aspect of the present invention is directed to a method for spraying a chemical solution according to any one of the first to the fifth aspects, wherein the wet paper contains recycled pulp at not less than 90% by mass.

A seventh aspect of the present invention is directed to a method for spraying a chemical solution according to any one of the first to the sixth aspects, wherein the chemical solution is an anti-soiling agent composition including at least one kind selected from the group consisting of amino modified silicone oil, epoxy modified silicone oil, polyether modified silicone oil, polybutene, a vegetable oil, and synthetic ester oil; and an absolute value of a zeta potential of the chemical solution is 3 to 100 mV.

### Advantageous Effects of Invention

In the method for spraying a chemical solution of the present invention, since two nozzle devices are used, a travel distance of each nozzle device can be decreased. Therefore, even with so-called wide wet paper, a sufficient amount of the chemical solution can be given onto the corresponding dryer roller.

At that time, a first nozzle device of the two nozzle devices is assigned to an area between a position corresponding to an end of the wet paper and a position corresponding to the center of the wet paper along a rail, and a second nozzle device is assigned to an area between the position corresponding to the center of the wet paper and a position corresponding to the other end of the wet paper along the rail, so as to improve efficiency of giving the chemical solution and thus make it possible to give the chemical solution onto the whole dryer roller more uniformly.

In a method for spraying a chemical solution according to the present invention, productivity improves and thus paper products can be produced at a lower cost by setting the rotational speed Vd of the dryer roller within the above-mentioned range. In addition, when setting the total amount of the chemical solution to be sprayed, the time T required for the two nozzle devices each to travel one-way, and the number of contacts N that a point on the dryer roller surface makes contact with the wet paper during the time T within the above-mentioned ranges, respectively, and further, when adjusting these so as to satisfy the relationship of N=T*Vd in such ranges, even in the case where the chemical solution is sprayed onto the dryer roller rotating at a high speed with the nozzle devices being reciprocated along the width direction, a sufficient amount of the chemical solution can be remained on the surface of the dryer roller.

For this reason, within the above-mentioned range of the number of contacts, even if the transported wet paper absorbs the chemical solution, given to the surface of the dryer roller, at every contact, the sufficient amount of the chemical solution remains, so that a shortage of the chemical solution partially on the dryer roller can be prevented. As a result, the effect based on the chemical solution can be fully exhibited.

In a method for spraying a chemical solution according to the present invention, the chemical solution can be sprayed stably by the two nozzle devices by setting the average moving speed Vn of the two nozzle devices within the above-mentioned range, and the effect of the present invention can be surely exhibited by setting the paper width W of the wet paper within the above-mentioned range.

Further, since the time T required for the two nozzle devices each to travel one-way can be calculated from the average moving speed Vn and the paper width W of the wet paper, for example, even in the case where the paper width changes by a setup change of the wet paper, a sufficient amount of the chemical solution can be remained on the surface of the dryer roller by adjusting the moving speed of the nozzle devices or the like.

In a method for giving a chemical solution according to the present invention, productivity improves and thus paper products can be produced at a lower cost by setting the transportation speed Vp of the wet paper within the above-mentioned range, and the effect of the present invention can be surely exhibited by setting the diameter D of the dryer roller within the above-mentioned range.

Further, since the rotational speed Vd of the dryer roller can be calculated from the transportation speed Vp of the wet paper and the diameter D of the dryer roller, for example, by adjusting the transportation speed Vp of the wet paper or the like depending on the diameter of the dryer roller, a sufficient amount of the chemical solution can be remained on the surface of the dryer roller.

In a method for giving a chemical solution according to the present invention, when setting a width of a sprayed portion on the dryer roller of the chemical solution instantaneously sprayed radially each by the two nozzle devices having the same construction within the above-mentioned range, lateral scattering of the chemical solution is restrained so that the chemical solution can be efficiently given to the dryer roller.

In a method for giving a chemical solution according to the present invention, in the case where the wet paper contains recycled pulp at not less than 90% by mass, since the wet paper tends to absorb a larger amount of the chemical solution, the effect of the present invention can be more exhibited.

In a method for giving a chemical solution according to the present invention, in the case where the chemical solution is an anti-soiling agent composition including at least one kind selected from the group consisting of amino modified silicone oil, epoxy modified silicone oil, polyether modified silicone oil, polybutene, a vegetable oil, and synthetic ester oil, the adhesion of paper powder or pitch contained in the wet paper to the dryer roller can be prevented.

At that time, in the case where an absolute value of a zeta potential of the chemical solution is 3 to 100 mV, the chemical solution easily adheres to the dryer roller, a sufficient amount of the chemical solution can be remained on the surface of the dryer roller.

### BRIEF DESCRIPTION OF DRAWINGS

FIG. 1 is a schematic view illustrating a dry part of a paper-making machine in which a method for spraying a chemical solution according to the present embodiment is used.

FIG. 2 is a perspective view schematically illustrating a state in which nozzle devices spray a chemical solution onto a dryer roller by a method for spraying a chemical solution according to the present embodiment.

FIGS. 3(a) and 3(b) are each a development equivalent to a single rotation of the dryer roller in which the chemical solution has been sprayed onto the dryer roller by a method for spraying a chemical solution according to the present embodiment.

FIG. 4 is an explanatory view for explaining a number of contacts in a method for spraying a chemical solution according to the present embodiment.

### DESCRIPTION OF EMBODIMENTS

Hereinafter, a preferable embodiment of the present invention is described in detail with reference to the drawings as necessary. Note that, in the drawings, the same components are given the same reference numerals, and redundant descriptions are omitted. Further, the vertical and horizontal positional relationships are based on the positional relationships illustrated in the drawings, unless otherwise noted. Furthermore, the dimensional ratios are not limited to the ratios illustrated in the drawings.

A method for spraying a chemical solution according to the present embodiment is used in a dry part of a paper-making machine.

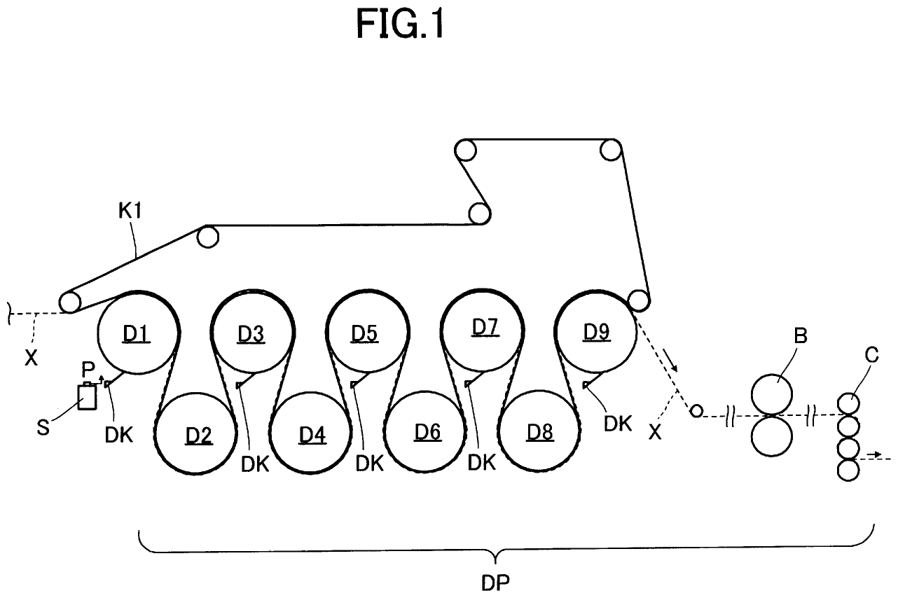

FIG. 1 is a schematic view illustrating a dry part of a paper-making machine in which a method for spraying a chemical solution according to the present embodiment is used.

As shown in FIG. 1, a dry part DP of a paper-making machine includes: a plurality of cylindrical dryer rollers (Yankee dryers) D1, D2, D3, D4, D5, D6, D7, D8, and D9 (hereinafter referred to as “D1 to D9”) configured to guide wet paper X with heat-dried; doctor blades DK configured to be in contact with the dryer rollers D1, D3, D5, D7, and D9; canvas K1 configured to move while pressing the wet paper X against surfaces of the dryer rollers D1 to D9; breaker stack rollers B configured to rotate while temporarily pressing the wet paper X heat-dried by the dryer rollers D1 to D9; and calender rollers C configured to rotate while pressing the wet paper X pressed by the breaker stack rollers B temporarily. That is, the dry part DP includes the dryer rollers D1 to D9, the canvas K1, the breaker stack rollers B, and the calender rollers C.

The method for spraying a chemical solution according to the present embodiment is used for the dryer rollers D1 to D9.

In the dry part DP, the wet paper X fed to the dry part is pressed by the canvas K1 into contact with the surfaces of the rotating dryer rollers D1 to D9. Thereby, the wet paper X adheres to the dryer rollers D1 to D9 so as to be heat-dried and guided by the rotating dryer rollers D1 to D9 and the moving canvas K1.

After that, smoothness and paper thickness of the wet paper X are gently adjusted by the breaker stack rollers B. Then, smoothness and paper thickness of the wet paper X are again adjusted by the calender rollers C. Thus, the wet paper X is made denser to be made into paper.

Note here that the dryer rollers D1 to D9, the canvas K1, the breaker stack rollers B, and the calender rollers C, rotate at approximately the same speed as that of the wet paper X.

In the dry part DP, the doctor blades DK are in contact with the dryer rollers D1, D3, D5, D7, and D9. Thus, when the dryer rollers D1, D3, D5, D7, and D9 rotate, paper powder or pitch adhered thereto is scraped away by the doctor blades DK.

Further, the canvas K1 is guided under a sufficient tension by a plurality of canvas rollers located over the dryer rollers D1 to D9.

In a method for spraying a chemical solution, the chemical solution is to be sprayed by a nozzle device S in a position of the arrow P shown in FIG. 1 onto the dryer roller D1 near the uppermost stream side of the dryer rollers D1 to D9.

At that time, a part of the chemical solution sprayed onto the dryer roller D1 forms a membrane on the surface of the dryer roller D1, and a part thereof is absorbed by the wet paper X.

Then, the chemical solution absorbed by the wet paper X will be given to the canvas K1 and the following dryer rollers D2 to D9 via the wet paper X.

Therefore, it is necessary to make the wet paper X sufficiently absorb the chemical solution in the method for spraying a chemical solution. Also, since it is necessary to form a sufficient membrane on the dryer roller D1, it is very important to spray a sufficient amount of the chemical solution onto the dryer roller D1 near the uppermost stream side.

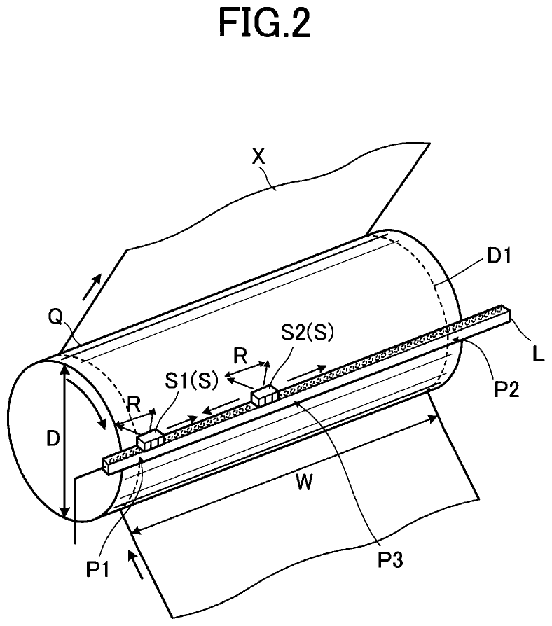

FIG. 2 is a perspective view schematically illustrating a state in which nozzle devices spray a chemical solution onto a dryer roller by a method for spraying a chemical solution according to the present embodiment.

In the method for spraying a chemical solution as shown in FIG. 2, the chemical solution is sprayed onto the dryer roller D1 by the two nozzle devices S disposed at a certain interval therebetween with the two nozzle devices S each reciprocated along a rail L extended in the width direction of the dryer roller D1 in a state that the dryer roller D1 is being rotated.

In the method for spraying a chemical solution, since the two nozzle devices S are used, the travel distance of each nozzle device S can be decreased. Therefore, even with so-called wide wet paper, a sufficient amount of the chemical solution can be given onto the corresponding dryer roller D1.

Further, the two nozzle devices S are herein referred to as a first nozzle device S1 (a nozzle device on the left side in FIG. 2) and a second nozzle device S2 (a nozzle device on the right side in FIG. 2) for convenience' sake.

At that time, in the method for spraying a chemical solution, the total amount of the chemical solution sprayed by the two nozzle devices S (just referred to as hereinafter “the total sprayed amount of the chemical solution”) is 0.3 to 500 mg/m² as an effective component amount, preferably 1 to 250 mg/m², and more preferably 1.5 to 95 mg/m². Further, “an effective component amount” means the total amount of components, such as oils, a surface active agent, resin, and mineral salt, i.e., other than water, in the chemical solution.

Therefore, such a total sprayed amount means the effective component amount contained in the chemical solution given per 1 m² of the dryer roller.

When the total sprayed amount of the chemical solution is less than 0.3 mg/m² as an effective component amount, the chemical solution is absorbed by the wet paper and thus the effect based on the chemical solution cannot fully be exhibited. When the total sprayed amount of the chemical solution is more than 500 mg/m² as an effective component amount, there is a possibility that the solid content contained in the chemical solution itself may cause contamination.

In the method for spraying a chemical solution, such wet paper X as containing recycled pulp at not less than 90% by mass is preferably used. In this case, since the wet paper X tends to absorb an increased amount of the chemical solution, the effect of the present invention can be more exhibited.

Further, the transportation speed Vp (paper-making speed) of the wet paper X is preferably not less than 600 m/min, more preferably 600 to 2000 m/min, more preferably 600 to 1800 m/min, and even more preferably 800 to 1800 m/min. In this case, productivity improves and thus paper products can be produced at a lower cost.

As mentioned above, the dryer roller D1 rotates at approximately the same speed as the transportation speed Vp of the wet paper X.

At that time, the diameter D of the dryer roller is preferably 1.50 to 1.85 m.

Thus, the rotational speed Vd of the dryer roller D1 is calculated in such a manner that the transportation speed Vp of the wet paper X and the diameter D of the dryer roller D1 satisfy Vd=Vp/πD.

Specifically, the rotational speed Vd of the dryer roller D1 is not less than 100 times/min, preferably 100 to 425 times/min, more preferably 100 to 320 times/min, and even more preferably 120 to 320 times/min. In this case, productivity improves and thus paper products can be produced at a lower cost.

Also, it is possible to fix the rotational speed Vd of the dryer roller D1 in this range, and then to change the transportation speed Vp of the wet paper X or the diameter D of the dryer roller D1 so as to satisfy the above-mentioned formula.

In the method for spraying a chemical solution, the first nozzle device S1 and the second nozzle device S2 have the same structure, wherein both of them are to reciprocate in the width direction along a rail L by a belt (not shown) built in the rail L.

At that time, the first nozzle device S1 is arranged to reciprocate between a position P1 and a position P3 of the rail L: wherein the position P1 of the rail L corresponds to an end of the wet paper X, in other words, when a portion of the dryer roller D1, which is to make contact with the end of wet paper X, rotates, and comes to the rail L side, the position P1 of the rail L opposes to such a portion; and the position P3 of the rail L corresponds to the center of the wet paper X, in other words, when a portion of the dryer roller D1, which is to make contact with the center of wet paper X, rotates, and comes to the rail L side, the position P3 of the rail L opposes to such a portion.

Then, the second nozzle device S2 is arranged to reciprocate between a position P3 and a position P2 of the rail L: the position P3 of the rail L corresponds to the center of the wet paper X, in other words, when a portion of the dryer roller D1, which is to make contact with the center of wet paper X, rotates, and comes to the rail L side, the position P3 of the rail L opposes to such a portion; and wherein the position P2 of the rail L corresponds to the other end of the wet paper X, in other words, when a portion of the dryer roller D1, which is to make contact with the other end of wet paper X, rotates, and comes to the rail L side, the position P2 of the rail L opposes to such a portion.

Further, such movement control is performed using a plurality of sensors (not shown) attached to the rail L.

Thereby, efficiency of giving the chemical solution is improved and the chemical solution can be uniformly given onto the whole dryer roller D1 in the method for spraying the chemical solution.

The nozzle device S is arranged to instantaneously spray the chemical solution radially.

The width R of a sprayed portion of the chemical solution on the dryer roller D1 instantaneously sprayed by the nozzle device S is preferably 1.5 to 9 cm, and more preferably 3 to 6 cm.

When the width R of the sprayed portion is less than 1.5 cm, there are drawbacks of taking a longer time for the nozzle device S to respray after reciprocation and making the number of contacts with the wet paper, as mentioned below, more than that in the case where the width R of the sprayed portion is within the above-mentioned range. On the other hand, when the width R of the sprayed portion is longer than 9 cm, there is a drawback of making the efficiency of adhesion to the target lower by scattering caused on ends of the sprayed portion due to low-impact, than that in the case where the width R of the sprayed portion is within the above-mentioned range. Further, such a width R of the sprayed portion means the maximum width of the sprayed portion of the chemical solution in a width direction.

In the method for spraying a chemical solution, the distance of the one-way travel of each nozzle device S corresponds to a half of the paper width W of the wet paper. That is, the distance of the back-and-forth travel of the nozzle device S corresponds to the paper width W of the wet paper.

The wet paper having a paper width W of not less than 4 m is preferably used from a viewpoint of productivity, while the wet paper having a paper width of not more than 12 m is preferably used from a viewpoint of the yield.

The nozzle device S is arranged to reciprocate at a fixed speed along the rail L. Its movement is accompanied by deceleration and acceleration at the turning points on both ends, however, its speed is not more than the above-mentioned fixed speed.

A fixed speed Vmax can be set up, for example, by dividing a travel distance H of the nozzle device S during a single rotation of the dryer roller D1 by the time of the single rotation of the dryer roller D1 (an inverse number of the rotational speed Vd).

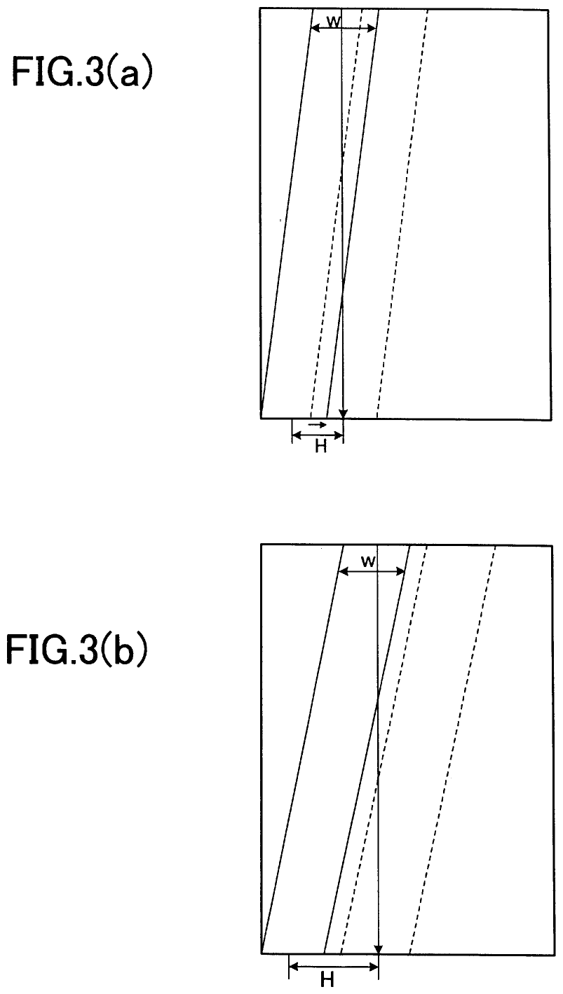

FIGS. 3(a) and 3(b) are each a development equivalent to a single rotation of the dryer roller in the case where the chemical solution has been sprayed onto the dryer roller by the method for spraying the chemical solution according to the present embodiment.

In the method for spraying a chemical solution, during a single rotation of the dryer roller D1, the nozzle device S continuously sprays the chemical solution while moving in a width direction. Therefore, as shown in FIGS. 3(a) and 3(b), the chemical solution forms a sprayed portion having a parallelogram shape in the development equivalent to a single rotation of the dryer roller.

For example, as shown in FIG. 3 (a), in the case where the width R of the sprayed portion of the chemical solution is larger than the travel distance H of the nozzle device S for a single rotation of the dryer roller D1, sprayed portions may overlap. On the other hand, as shown in FIG. 3(b), in the case where the width R of the sprayed portion of the chemical solution is smaller than the travel distance H of the nozzle device S for a single rotation of the dryer roller D1, a gap may be caused between both of the sprayed portions.

Therefore, in order to give the chemical solution onto the dryer roller D1 so as not to cause a gap between sprayed portions, it is preferable to set up the travel distance H of the nozzle device S for a single rotation of the dryer roller D1 and the width R of the sprayed portion of the chemical solution so as to satisfy H≤R.

Thereby, the fixed speed Vmax, which enables the nozzle device S to give the chemical solution so as not to cause a gap, can be calculated. Further, as mentioned above, even in the case where the travel of the nozzle device S is accompanied by deceleration and acceleration at the turning points on both ends, since its speed is not more than the above-mentioned fixed speed Vmax, a gap may not be caused.

Specifically, the travel distance H of the nozzle device S during a single rotation of the dryer roller D1 is preferably 1.5 to 45 cm, and more preferably 1.5 to 30 cm. When the travel distance H is shorter than 1.5 cm, there are drawbacks of taking a longer time for the nozzle device S to respray after reciprocation and making the number of contacts with the wet paper, as mentioned below, more than that in the case where the travel distance H is within the above-mentioned range. On the other hand, when the travel distance H is longer than 45 cm, there is a drawback of making the efficiency of adhesion to the target lower by scattering caused on ends of the sprayed portion due to low-impact, than that in the case where the travel distance H is within the above-mentioned range.

The average moving speed Vn of the nozzle device S is set with consideration for the above-mentioned fixed speed Vmax as well as the above-mentioned deceleration and acceleration at the turning points.

Specifically, the average moving speed Vn of the nozzle device is preferably 4 to 10 m/min. In this case, the chemical solution can be sprayed more stably onto the dryer roller.

Then, the time T required for the nozzle device S to travel one-way can be calculated in such a manner that the paper width W of the wet paper and the average moving speed Vn of the nozzle device S satisfy the relationship of T=W/2Vn. Further, the time required to travel one-way means a half of the time required for the nozzle device S to reciprocate, in which the one-way may be forth motion or back motion.

Specifically, the time T required for the nozzle device S to travel one-way is 0.2 to 1.5 minutes.

When the time T is less than 0.2 minutes, there is a possibility that high friction between the nozzle device S and the rail L may cause failure. When the time T is more than 1.5 minutes, there are drawbacks of taking a longer time for the nozzle device S to respray the chemical solution after reciprocation, and there is a tendency that the effect based on the chemical solution is hard to be obtained.

Further, it is possible to fix the time T required for the nozzle device S to travel one-way in this range, and then to change the paper width W of the wet paper or the average moving speed Vn of the nozzle device S so as to satisfy the above-mentioned formula.

Since the dryer roller D1 rotates at a high speed, as mentioned above, arbitrary one point Q (see FIG. 2) on the surface of the dryer roller D1 makes contact with the wet paper X repeatedly at every rotation.

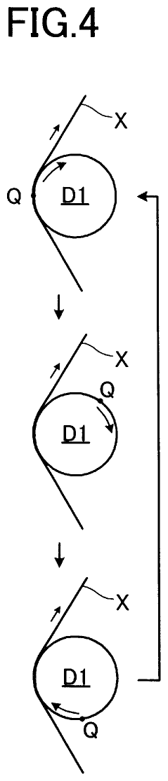

FIG. 4 is an explanatory view for explaining the number of contacts in the method for spraying the chemical solution according to the present embodiment.

As shown in FIG. 4, the point Q on the surface of the dryer roller D1 starts with a state of being in contact with the wet paper X, and separates from the wet paper X by rotation of the dryer roller D1, and then, as the dryer roller D1 rotates, makes contact with the wet paper X again. The repeat count of the cycle, in which this one point Q makes contact with the wet paper X, corresponds to the number of contacts N.

Here, the number of contacts N of making contact with the wet paper X during the time T required for the nozzle device S to travel one-way can be calculated in such a manner that the time T required for the nozzle device S to travel one-way and the rotational speed Vd of the dryer roller D1 satisfy the relationship of N=T*Vd.

In setting up the number of contacts N so as to satisfy this relationship, even in the case where the chemical solution is sprayed onto the dryer roller D1 rotating at a high speed by the nozzle device S reciprocating along the width direction, a sufficient amount of the chemical solution can be remained on the surface of the dryer roller D1.

Specifically, the number of contacts N is 30 to 250 times, preferably 50 to 160 times, and more preferably 80 to 140 times.

When the number of contacts N is less than 30 times, the amount of the chemical solution absorbed by the wet paper X decreases, while the amount of the chemical solution remained on the dryer roller D1 increases, so that the dryer roller D1 may be contaminated by the solid content contained in the chemical solution itself. When the number of contacts N is not less than 250 times, the amount of the chemical solution absorbed by the wet paper increases, the dryer roller D1 may have insufficient amount of the chemical solution partially.

The chemical solution preferably has an absolute value of a zeta potential of 3 to 100 mV, and more preferably 20 to 80 mV. When the absolute value of a zeta potential is less than 3 mV, adsorption power of the chemical solution to the dryer roller D1 is smaller than that in the case where the absolute value of a zeta potential is within the above-mentioned range, which may cause a possibility that the amount of the chemical solution remained on the dryer roller D1 may become insufficient. When the absolute value of a zeta potential is more than 100 mV, adsorption power of the chemical solution to the dryer roller D1 is larger than that in the case where the absolute value of a zeta potential is within the above-mentioned range, an exceeding amount of the chemical solution remains on the dryer roller D1, as a result, which may cause a possibility that the dryer roller D1 may be contaminated by the solid content contained in the chemical solution itself

As a chemical solution used for the method for spraying a chemical solution, examples include an anti-soiling agent composition, a release agent composition, and a cleaning agent composition.

Among them, the chemical solution preferably is an anti-soiling agent composition including at least an anti-soiling agent and water. In this case, the adhesion of paper powder and pitch contained in the wet paper to the dryer roller can be prevented.

An anti-soiling agent preferably contains at least one kind selected from the group consisting of amino-modified silicone oil, epoxy-modified silicone oil, polyether-modified silicone oil, polybutene, a vegetable oil, and synthetic ester oil, and more preferably contains amino-modified silicone oil, synthetic ester oil, or a vegetable oil.

Here, when an anti-soiling agent contains at least one kind of silicone oil selected from the group consisting of amino-modified silicone oil, epoxy-modified silicone oil, and polyether modified silicone oil, pH is preferably 3.0 to 6.0, a median diameter is preferably 0.05 to 1.2 μm, a viscosity is preferably not more than 100 mPa s, and a zeta potential is preferably 23 to 80 mV.

Further, when an anti-soiling agent contains at least one kind of non-silicone oil selected from the group consisting of polybutene, a vegetable oil, and synthetic ester oil, pH is preferably 8.5 to 10.5, a median diameter is preferably 0.05 to 1.2 μm, a viscosity is preferably not more than 100 mPa s, and a zeta potential is preferably −80 to −15 mV.

The preferred embodiment of the present invention has been described above, but the invention is not limited to the above-described embodiments.

In the method for spraying the chemical solution according to this embodiment, the chemical solution is sprayed by nozzle device S onto the dryer roller D1 near the uppermost stream side of the dryer rollers D1 to D9. However, it is also possible to spray the chemical solution on other dryer rollers D2 to D9 as a matter of course.

For example, it is effective when the chemical solution is sprayed also on the dryer roller D5 positioned in the middle in addition to the dryer roller D1.

In the method for spraying the chemical solution according to the present embodiment, the fixed speed Vmax of the nozzle device S is calculated in such a manner that the travel distance H of the nozzle device S during a single rotation of the dryer roller D1 and the width R of the sprayed portion of the chemical solution satisfy the relationship of H≤R, however, this calculation method is not indispensable. That is, based on the condition that a gap is caused between sprayed portions, the fixed speed Vmax of the nozzle device S may be calculated. Further, even in the case where a gap is caused between sprayed portions, since the nozzle device S is constructed to spray the chemical solution with repetitive reciprocation, the gap will be canceled after all.

In the method for spraying the chemical solution according to the present embodiment, spraying is conducted toward the dryer roller D1, it is also possible to spray toward the canvas K1, the breaker stack roller B, or the calender roller C.

In the method for spraying the chemical solution according to the present embodiment, the chemical solution is sprayed using two nozzle devices S, the chemical solution may be sprayed by one nozzle device S, and the chemical solution may be sprayed by three or more nozzle devices S.

### EXAMPLES

Hereinafter, the present invention will be described in further detail based on Examples, but the present invention is not limited to Examples.

### Examples 1 to 28 and Comparative Examples 1 to 14

In a real paper-making machine as shown in FIG. 1, a chemical solution was sprayed onto a dryer roller D1 by using two nozzle devices, as shown in FIG. 2.

A paper width W of wet paper used here is 6 m, and a diameter D of the dryer roller was 1.83 m.

As the chemical solution, an anti-soiling agent composition including amino modified silicone oil having a zeta potential of 56.8 mV as a main component (trade name: DusClean CMS8144G made by MAINTECH CO., LTD.) was each used for Examples 1 to 20 and Comparative Examples 1 to 8, an anti-soiling agent composition including polyether modified silicone oil having a zeta potential of 0 mV as a main component was each used for Examples 21 to 24 and Comparative Examples 9 to 11, and an anti-soiling agent composition including synthetic ester oil as a main component (trade name: DusClean PBE2677N made by MAINTECH CO., LTD.) having a zeta potential of −64.0 mV was each used for Examples 25 to 28 and Comparative Examples 12 to 14, wherein each composition was given to the dryer roller D1 so that the total sprayed amount of the chemical solution was set to 20 mg/m² as an effective component amount.

The other conditions, i.e., a transportation speed Vp of the wet paper, an average moving speed Vn of the nozzle devices, a rotational speed Vd of the dryer roller, a time T required for the nozzle devices each to travel one-way, and an absolute value (mV) of a zeta potential of the chemical solution were each adjusted, as shown in Table 1, and then the number of contacts N was each calculated from those values.

Further, as chemical agents used in Table 1, the anti-soiling agent composition including amino modified silicone oil as a main component is shown by “Am”, the anti-soiling agent composition including polyether modified silicone oil as a main component by “PE”, and the anti-soiling agent composition including synthetic ester oil as a main component by “ES”.

TABLE 1

| | Vp | Vn | Vd | | | |
|---|---|---|---|---|---|---|
| | (m/ | (m/ | (times/ | T | N | Chemical |
| | min) | min) | min) | (min) | (times) | agent |
| Example 1 | 800 | 2.0 | 139.2 | 1.5 | 209 | Am |
| Example 2 | 800 | 3.0 | 139.2 | 1.0 | 139 | Am |
| Example 3 | 800 | 4.0 | 139.2 | 0.8 | 104 | Am |
| Example 4 | 800 | 6.0 | 139.2 | 0.5 | 70 | Am |
| Example 5 | 800 | 8.0 | 139.2 | 0.4 | 52 | Am |
| Example 6 | 800 | 10.0 | 139.2 | 0.3 | 42 | Am |
| Example 7 | 1000 | 3.0 | 173.9 | 1.0 | 174 | Am |
| Example 8 | 1000 | 4.0 | 173.9 | 0.8 | 130 | Am |
| Example 9 | 1000 | 6.0 | 173.9 | 0.5 | 87 | Am |
| Example 10 | 1000 | 8.0 | 173.9 | 0.4 | 65 | Am |
| Example 11 | 1000 | 10.0 | 173.9 | 0.3 | 52 | Am |
| Example 12 | 1200 | 3.0 | 208.7 | 1.0 | 209 | Am |
| Example 13 | 1200 | 4.0 | 208.7 | 0.8 | 157 | Am |
| Example 14 | 1200 | 6.0 | 208.7 | 0.5 | 104 | Am |
| Example 15 | 1200 | 8.0 | 208.7 | 0.4 | 78 | Am |
| Example 16 | 1200 | 10.0 | 208.7 | 0.3 | 63 | Am |
| Example 17 | 1500 | 4.0 | 260.9 | 0.8 | 196 | Am |
| Example 18 | 1500 | 6.0 | 260.9 | 0.5 | 130 | Am |
| Example 19 | 1500 | 8.0 | 260.9 | 0.4 | 98 | Am |
| Example 20 | 1500 | 10.0 | 260.9 | 0.3 | 78 | Am |
| Example 21 | 1500 | 4.0 | 260.9 | 0.8 | 196 | PE |
| Example 22 | 1500 | 6.0 | 260.9 | 0.5 | 130 | PE |
| Example 23 | 1500 | 8.0 | 260.9 | 0.4 | 98 | PE |
| Example 24 | 1500 | 10.0 | 260.9 | 0.3 | 78 | PE |
| Example 25 | 1500 | 4.0 | 260.9 | 0.8 | 196 | ES |
| Example 26 | 1500 | 6.0 | 260.9 | 0.5 | 130 | ES |
| Example 27 | 1500 | 8.0 | 260.9 | 0.4 | 98 | ES |
| Example 28 | 1500 | 10.0 | 260.9 | 0.3 | 78 | ES |
| Comparative | 800 | 1.5 | 139.2 | 2.0 | 278 | Am |
| Example 1 | | | | | | |
| Comparative | 1000 | 1.5 | 173.9 | 2.0 | 348 | Am |
| Example 2 | | | | | | |
| Comparative | 1000 | 2.0 | 173.9 | 1.5 | 261 | Am |
| Example 3 | | | | | | |
| Comparative | 1200 | 1.5 | 208.7 | 2.0 | 417 | Am |
| Example 4 | | | | | | |
| Comparative | 1200 | 2.0 | 208.7 | 1.5 | 313 | Am |
| Example 5 | | | | | | |
| Comparative | 1500 | 1.5 | 260.9 | 2.0 | 522 | Am |
| Example 6 | | | | | | |
| Comparative | 1500 | 2.0 | 260.9 | 1.5 | 391 | Am |
| Example 7 | | | | | | |
| Comparative | 1500 | 3.0 | 260.9 | 1.0 | 261 | Am |
| Example 8 | | | | | | |
| Comparative | 1500 | 1.5 | 260.9 | 2.0 | 522 | PE |
| Example 9 | | | | | | |
| Comparative | 1500 | 2.0 | 260.9 | 1.5 | 391 | PE |
| Example 10 | | | | | | |
| Comparative | 1500 | 3.0 | 260.9 | 1.0 | 261 | PE |
| Example 11 | | | | | | |
| Comparative | 1500 | 1.5 | 260.9 | 2.0 | 522 | ES |
| Example 12 | | | | | | |
| Comparative | 1500 | 2.0 | 260.9 | 1.5 | 391 | ES |
| Example 13 | | | | | | |
| Comparative | 1500 | 3.0 | 260.9 | 1.0 | 261 | ES |
| Example 14 | | | | | | |

### [Evaluation Method]

As for Examples 1 to 28 and Comparative Examples 1 to 14, the state of contamination by pitch, paper powder, or the like attached to the surface of the dryer roller D1 after a lapse of one hour was each visually evaluated.

In evaluation, the state where the contamination did not adhere to the dryer roller D1 surface is marked with “excellent”, the state where the contamination adhered to the dryer roller D1 surface on about ten percent of the whole surface of the dryer roller D1 is marked with “good”, the state where the contamination adhered to the dryer roller D1 surface on about 10 to 30 percent of the whole surface of the dryer roller D1 is marked with “fair”, the state where the contamination adhered to the dryer roller D1 surface on not less than 30 percent of the whole surface of the dryer roller D1 is marked with “NG.” In the case where such an evaluation is “excellent”, “good”, or “fair”, it can be said that the contamination control effect based on the anti-soiling agent composition is exhibited.

Table 2 shows the results thus obtained.

TABLE 2

| | State of |
|---|---|
| | contamination |
| Example 1 | good |
| Example 2 | excellent |
| Example 3 | excellent |
| Example 4 | excellent |
| Example 5 | excellent |
| Example 6 | excellent |
| Example 7 | good |
| Example 8 | excellent |
| Example 9 | excellent |
| Example 10 | excellent |
| Example 11 | excellent |
| Example 12 | good |
| Example 13 | good |
| Example 14 | excellent |
| Example 15 | excellent |
| Example 16 | excellent |
| Example 17 | good |
| Example 18 | excellent |
| Example 19 | excellent |
| Example 20 | excellent |
| Example 21 | fair |
| Example 22 | fair |
| Example 23 | fair |
| Example 24 | fair |
| Example 25 | good |
| Example 26 | excellent |
| Example 27 | excellent |
| Example 28 | excellent |
| Comparative | NG |
| Example 1 | |
| Comparative | NG |
| Example 2 | |
| Comparative | NG |
| Example 3 | |
| Comparative | NG |
| Example 4 | |
| Comparative | NG |
| Example 5 | |
| Comparative | NG |
| Example 6 | |
| Comparative | NG |
| Example 7 | |
| Comparative | NG |
| Example 8 | |
| Comparative | NG |
| Example 9 | |
| Comparative | NG |
| Example 10 | |
| Comparative | NG |
| Example 11 | |
| Comparative | NG |
| Example 12 | |
| Comparative | NG |
| Example 13 | |
| Comparative | NG |
| Example 14 | |

As obvious from the result shown in Table 2, according to methods for spraying a chemical solution of Examples 1 to 28, compared with methods for spraying a chemical solution of Comparative Examples 1 to 14, contamination of the dryer rollers D1 can sufficiently be controlled, thus it can be said that the anti-soiling agent composition sufficiently remains on the surface of the dryer rollers D1, and the effect thereby is exhibited.

Further, in Examples 1 to 20 each using the anti-soiling agent composition of which absolute value of a zeta potential is 56.8 mV, and in Examples 25 to 28 each using the anti-soiling agent composition having the absolute value of a zeta potential of 64.0 mV, the contamination control effect is more excellent. Further, when the number of contacts is set as 42 to 139 times among them, the contamination control effect is even further excellent.

### INDUSTRIAL APPLICABILITY

A method for spraying a chemical solution according to the present invention can be suitably used as a method for spraying a chemical solution onto a dry part of a paper-making machine. According to the present invention, the chemical solution is sprayed onto a surface of a dryer roller with a nozzle device reciprocated in the width direction of the dryer roller rotating at a high speed, whereby a sufficient amount of the chemical solution can be remained on the surface of the dryer roller.

### REFERENCE SIGNS LIST

B . . . breaker stack roller,
C . . . calender roller,
D . . . diameter,
D1, D2, D3, D4, D5, D6, D7, D8, D9 . . . dryer roller,
DK . . . doctor blade,
DP . . . dry part,
H . . . travel distance,
K1 . . . canvas,
L . . . rail,
P1, P2, P3 . . . position,
Q . . . one point,
R . . . width of a sprayed portion,
S . . . nozzle device(s),
S1 . . . first nozzle device,
S2 . . . second Nozzle device,
W . . . paper width,
X . . . wet paper.

1. A method for spraying a chemical solution, comprising: spraying the chemical solution onto a dryer roller by two nozzle devices disposed at a certain interval therebetween with the two nozzle devices each reciprocated along a rail extended in the width direction of the dryer roller in a state that the dryer roller, for guiding wet paper, is being rotated, in a dry part of a paper-making machine,
wherein a time T required for the two nozzle devices each to travel one-way is set as 0.2 to 1.5 minutes;
a rotational speed Vd of the dryer roller is set as not less than 100 times/min;
a number of contacts N that a point on the dryer roller surface makes contact with the wet paper during the time T is set as 30 to 250 times;
the time T, the rotational speed Vd, and the number of contacts N satisfy the relationship of N=T*Vd; and
a total amount of the sprayed chemical solution is set as 0.3 to 500 mg/m² as an effective component amount.

2. A method for spraying a chemical solution according to claim 1, wherein a first nozzle device of the two nozzle devices is arranged to reciprocate between a position corresponding to an end of the wet paper and a position corresponding to the center of the wet paper along the rail, and a second nozzle device thereof is arranged to reciprocate between a position corresponding to the other end of the wet paper and a position corresponding to the center of the wet paper along the rail.

3. A method for spraying a chemical solution according to claim 1,
wherein an average moving speed Vn of the two nozzle devices is each set as 4 to 10 m/min;
a paper width W of the wet paper is set as 4 to 12 m; and
the average moving speed Vn, the paper width W, and the time T satisfy the relationship of T=W/2Vn.

4. A method for spraying a chemical solution according to claim 1,
wherein a transportation speed Vp of the wet paper is set as not less than 600 m/min;
a diameter D of the dryer roller is set as 1.50 to 1.85 m; and
the rotational speed Vd, the transportation speed Vp, and the diameter D satisfy the relationship of Vd=Vp/πD.

5. A method for spraying a chemical solution according to claim 1,
wherein the two nozzle devices, having the same construction, are each arranged to spray the chemical solution onto the dryer roller radially; and
a width of a sprayed portion on the dryer roller of the chemical solution sprayed instantaneously by the nozzle device is set as 1.5 to 9 cm.

6. A method for spraying a chemical solution according to claim 1, wherein the wet paper contains recycled pulp at not less than 90% by mass.

7. A method for spraying a chemical solution according to claim 1,
wherein the chemical solution is an anti-soiling agent composition comprising at least one kind selected from the group consisting of amino modified silicone oil, epoxy modified silicone oil, polyether modified silicone oil, polybutene, a vegetable oil, and synthetic ester oil; and
an absolute value of a zeta potential of the chemical solution is 3 to 100 mV.
